(19) United States
(12) Patent Application Publication
(10) Pub. No.: US 2007/0186553 A1
(43) Pub. Date: Aug. 16, 2007

(54) Thermo-driven engine

(76) Inventor: Hsing-fa Lin, Shinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/354,035

(22) Filed: Feb. 15, 2006

(51) Int. Cl. F01B 29/08; F01K 25/02; F01K 25/00; F02C 1/04; F02G 1/00

(52) U.S. Cl. 60/650; 60/516

(57) ABSTRACT

A thermo-driven engine includes cylinders and at least one hydraulic motor. Each cylinder contains an air chamber and a hydraulic chamber therein. A piston is disposed between both chambers. The air chamber is intermittently heated to create pressure difference in the air chamber of the cylinder to force the piston moving to the hydraulic chamber, thus to drive the hydraulic motor for continuously generating power.

### BACKGROUND OF THE INVENTION

(a) Field of the Invention

The present invention relates to a thermo-driven engine, and more particularly, to one that has air chambers of cylinders intermittently heated for the air therein to create pressure difference to force pistons to move to hydraulic chambers thus to compress hydraulic liquid to drive a hydraulic motor for continuously generating power for utilization.

(b) Description of the Prior Art

Whereas there are many power sources available in the market, most of them operate by combusting petrol-chemical fuels including gasoline and diesel. An automobile or motorcycle is driven by power generated by combusting gasoline in the engine. Though the combustion of petrol-chemical fuel provides a convenient source to output power, exhaust created in the course of combustion is blamed for polluting the environment while it is prevented from an easy access to the fuel due to the energy crisis in the world. The consumption of petrol-chemical fuel is not ideal as the source for power output.

### SUMMARY OF THE INVENTION

The primary purpose of the present invention is to provide a thermo-driven engine that continuously generates power by effectively converting thermal energy into kinetics to drive a hydraulic motor without loss from heat exchange or lost pressure while promoting a consistent pressure output.

To achieve the purpose, the present invention comprises N cylinders including a first cylinder and a last cylinder wherein N refers to a positive integral and is not less than two. Each cylinder contains a pair of an air chamber and a hydraulic chamber with a piston disposed between both chambers. The air chamber contains a gaseous substance and the hydraulic chamber contains a liquid substance. The hydraulic chamber is provided with an inlet and an outlet.

One or a plurality of heat exchanger is disposed in relation to the air chamber of the cylinder and one heat exchanger is disposed in relation to the air chamber of the first cylinder.

2×N pipelines are provided with each pipeline disposed with a control valve and the control valve may be a one-way control to deliver the liquid substance.

One or a plurality of hydraulic motor containing an output shaft is disposed with an inlet and an outlet. When only one hydraulic motor is provided, it serves at the same time as the first and the last hydraulic motor; and when multiple hydraulic motors are provided, a first one and a last one are defined.

Accordingly, both the inlet and the outlet of the hydraulic chamber of each cylinder are respectively connected to the pipelines to separately import or export the liquid substance; meanwhile, both the inlet and the outlet of the hydraulic motor are respectively connected to the pipelines to separately import or export the liquid substance with the outlet of the hydraulic chamber of the first cylinder connected to the inlet of the first hydraulic motor and the outlet of the last hydraulic motor connected to the inlet of the hydraulic chamber of the first cylinder by the pipelines.

The present invention provides the following advantages:
1. High efficiency in converting thermal energy into kinetics without heat exchange loss and lost pressure;

2. Promoted consistent pressure output; and

3. The driven hydraulic motor continuously generates power to create acceleration from pressure output when provided with proper linkage.

### BRIEF DESCRIPTION OF THE DRAWINGS

FIG. 1 is a schematic view showing a construction of the present invention.

FIG. 2 is a schematic view showing a construction of a first preferred embodiment of the present invention.

FIG. 3 is a schematic view showing an operation status of the first preferred embodiment of the present invention.

FIG. 4 is a schematic view showing a construction of a second preferred embodiment of the present invention.

FIG. 5 is a schematic view showing a construction of a third preferred embodiment of the present invention.

FIG. 6 is a schematic view showing a construction of a fourth preferred embodiment of the present invention.

### DETAILED DESCRIPTION OF THE PREFERRED EMBODIMENTS

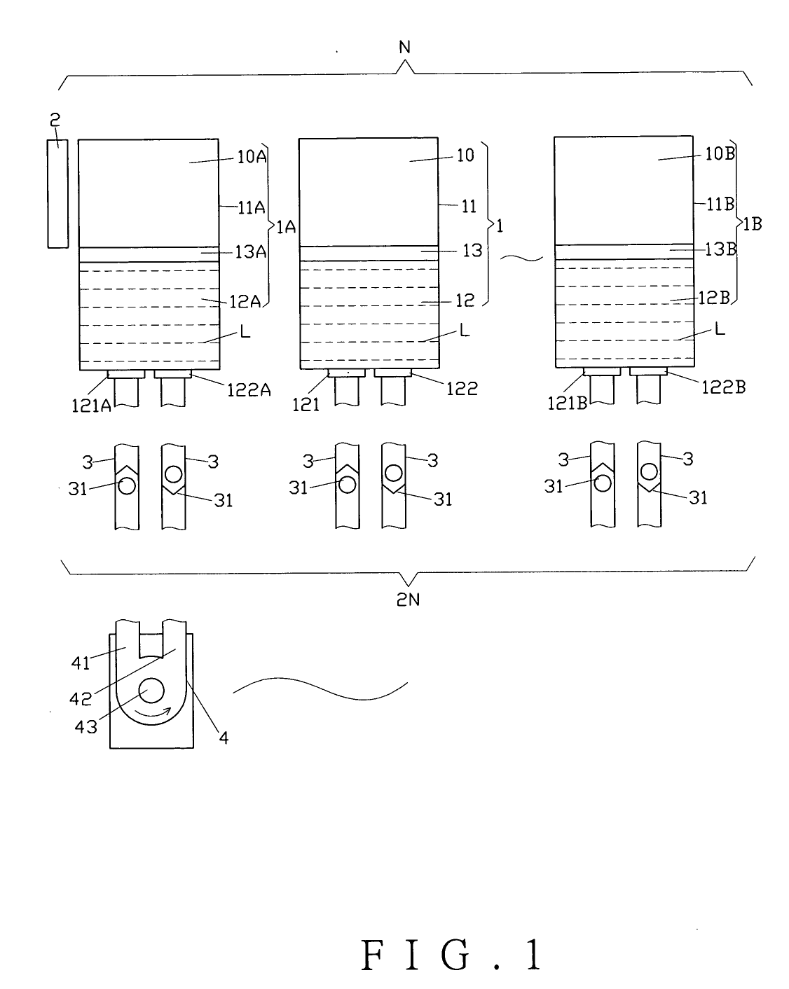

Referring to FIG. 1, a thermo-driven engine of the present invention comprises N cylinders (1) including a first cylinder (1A) and a last cylinder (1B) wherein N refers to a positive integral and is not less than 2. It is to be noted that all the cylinders including the first cylinder (1A) through the last cylinder (1B) are identical. The cylinder (1) includes a body (10) containing a pair of an air chamber (11) and a hydraulic chamber (12). A piston (13) is disposed between the air chamber (11) and the hydraulic chamber (12). The air chamber (11) contains a gaseous substance (not illustrated). The hydraulic chamber (12) contains a liquid substance (L), and the hydraulic chamber (12) is disposed with an inlet (121) and an outlet (122).

One or a plurality of heat exchanger (2) is disposed in relation to the air chamber (11) of the cylinder (1), and as illustrated in FIG. 1, an air chamber (11A) of the first chamber (1A) is disposed with the heat exchanger (2).

2×N pipelines (3) are provided with each pipeline (3) disposed with a control valve (31). The control valve (31) may be a one-way valve to deliver the liquid substance (L).

One or a plurality of a hydraulic motor (4) disposed with an inlet (41), outlet (42), and an output shaft (43). When multiple hydraulic motors (4) are provided, they include two hydraulic motors respectively designated as the first and the last hydraulic motors (not illustrated); or if only one hydraulic motor (4) is provided, the first hydraulic motor is also the last one.

Accordingly, both the inlet (121) and the outlet (122) of the hydraulic chamber (12) of each cylinder (1) are respectively connected with the pipelines (3) to separately import or export the liquid substance (L). Both the inlet (41) and the outlet (42) of the hydraulic motor (4) are also respectively connected with the pipelines (3) to separately import or export the liquid substance (L). An outlet (122A) of a first hydraulic chamber (12A) of the first cylinder (1A) is connected with the pipeline (3) to the inlet (41) of the first hydraulic motor (4) and the outlet (42) of the first hydraulic motor (4) is connected with the pipeline (3) to export the liquid substance (L) into the next cylinder (1) or the hydraulic motor (4) until it reaches the outlet (42) of the last hydraulic motor (4) where connected to an inlet (121A) of the hydraulic chamber (12A) of the first cylinder (1A).

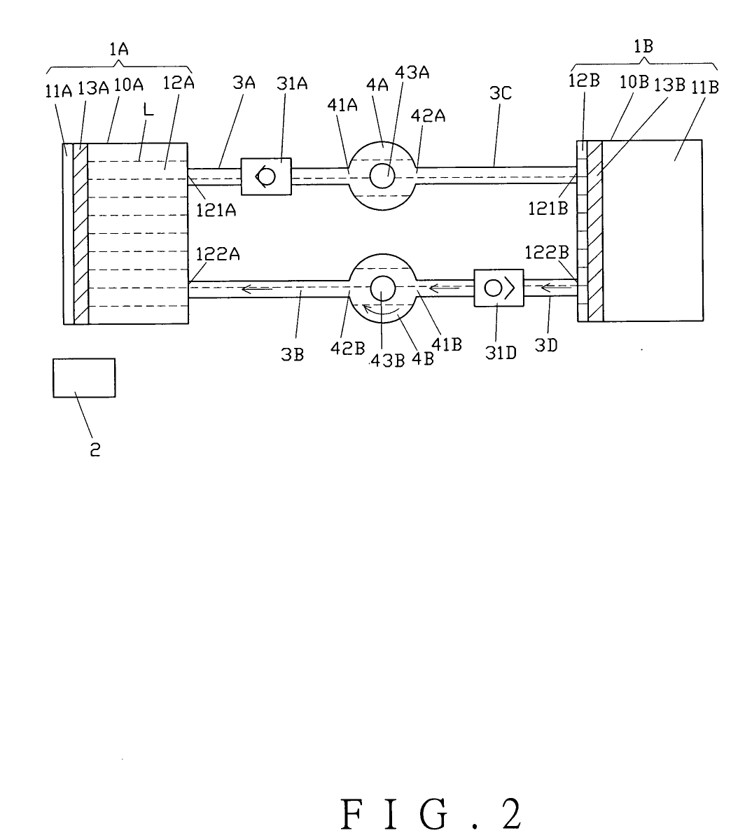

Now referring to FIG. 2, a first preferred embodiment of the present invention includes the first cylinder (1A) with its body (10A) containing the air chamber (11A) and the hydraulic chamber (12A). A piston (13A) is disposed between the air chamber (11A) and the hydraulic chamber (12A). The air chamber (11A) contains a gaseous substance (not illustrated) and the hydraulic chamber (12A) containing the liquid substance (L) is separately provided with the outlet (121A) connected to a first hydraulic pipeline (3A) and the inlet (122A) connected to a second hydraulic pipeline (3B). The first hydraulic pipeline (3A) is disposed with a one-way valve (31A).

The heat exchanger (2) is disposed in relation to the air chamber (11A) of the first cylinder (1A).

A first hydraulic motor (4A) is disposed with an inlet (41A) and an outlet (42A) with the former connected through the first hydraulic pipeline (3A) of the first cylinder (1A). An output shaft (43A) is disposed to the first hydraulic motor (4A).

A second hydraulic motor (4B) is disposed with an inlet (41B) and an outlet (42B) with the latter connected through the second hydraulic pipeline (3B) of the first cylinder (1A). The second hydraulic motor (4B) is disposed with an output shaft (43B).

The second cylinder (1B) is connected through both the hydraulic motors (4A, 4B). The second cylinder (1B) has a body (10B) containing an air chamber (11B) and a hydraulic chamber (12B). A piston (13B) is disposed between the air chamber (11B) and the hydraulic chamber (12B). The air chamber (11B) contains a gaseous substance and the hydraulic chamber (12B) contains the liquid substance (L). An inlet (121B) is disposed to the hydraulic chamber (12B) to connect through a third hydraulic pipeline (3C) and the outlet (42A) of the first hydraulic motor (4A) while an outlet (122B) is disposed to the hydraulic chamber (12B) to connect through a fourth hydraulic pipeline (3D) and the inlet (41B) of the second hydraulic motor (4B). A one-way valve (31D) is disposed to the fourth hydraulic pipeline (3D).

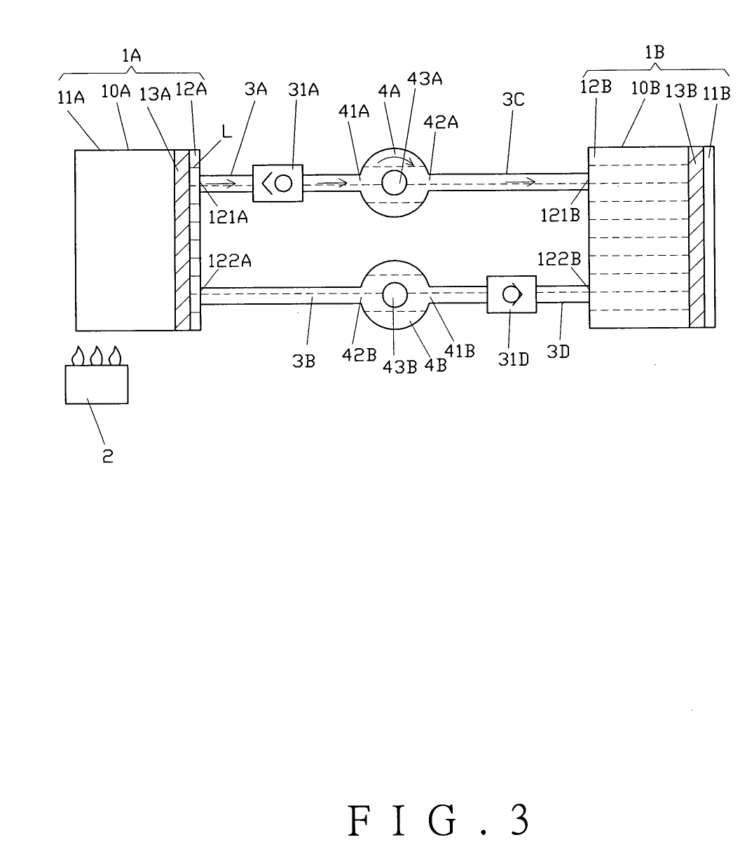

In operation of the present invention as illustrated in FIG. 3, the heat exchanger (2) is heated up and thus the air chamber (11A) of the first cylinder (1A) is heated up accordingly. The gaseous substance in the air chamber (11A) expands due to the heat to force the piston (13A) to drive the liquid substance (L) in the hydraulic chamber (12A) to flow in one direction through the first hydraulic pipeline (3A), the first hydraulic motor (4A), the third hydraulic pipeline (3C), and the hydraulic chamber (12B) of the second cylinder (1B) while turning around the output shaft (43A) of the first hydraulic motor (4A). Meanwhile, the piston (13B) of the second cylinder (1B) forces the gaseous substance in the air chamber (11B) to reduce and accumulate pressure until a balance state of the pressure is reached between both air chambers (11A, 11B). Once the heating to the heat exchanger (2) is stopped, the air temperature in the air chamber (11A) starts to drop and the gaseous substance also starts to reduce to allow the pressure in the air chamber (11B) of the second cylinder (1B) to force its piston (13B) to push back the liquid substance (L). The liquid substance (L) starts to flow in one direction through the fourth hydraulic pipeline (3D), the second hydraulic motor (4B), the second hydraulic pipeline (3B) to return to the hydraulic chamber (12A) of the first cylinder (1A) while causing the output shaft (43B) of the second hydraulic motor (4B) to turn around for output. Accordingly, the heat exchanger (2) reciprocally and intermittently heats up the air chamber (11A) of the first cylinder (1A) for both the first and the second hydraulic motors (4A, 4B) to alternatively output.

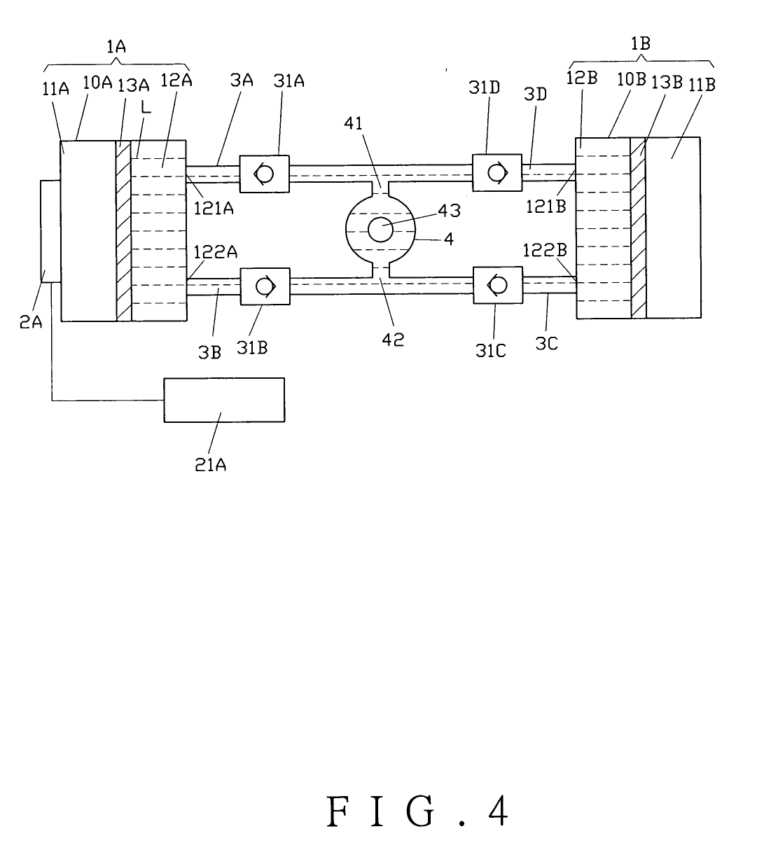

As illustrated in FIG. 4, a second preferred embodiment of the present invention differs from the first preferred embodiment in that only one hydraulic motor (4) is mounted. Therefore, multiple one-way valves (31A, 31B, 31C, 31D) are respectively provided to the first, the second, the third, and the fourth pipelines (3A, 3B, 3C, 3D) with the fourth hydraulic pipeline (3D) connected back to the inlet (41) of the hydraulic motor (4); the outlet (42) of the hydraulic motor (4) is connected through the second hydraulic pipeline (3B); and the heat exchanger (2A) is connected to a controller (21A) to control the intermittent heating in the process similar to that of the first preferred embodiment.

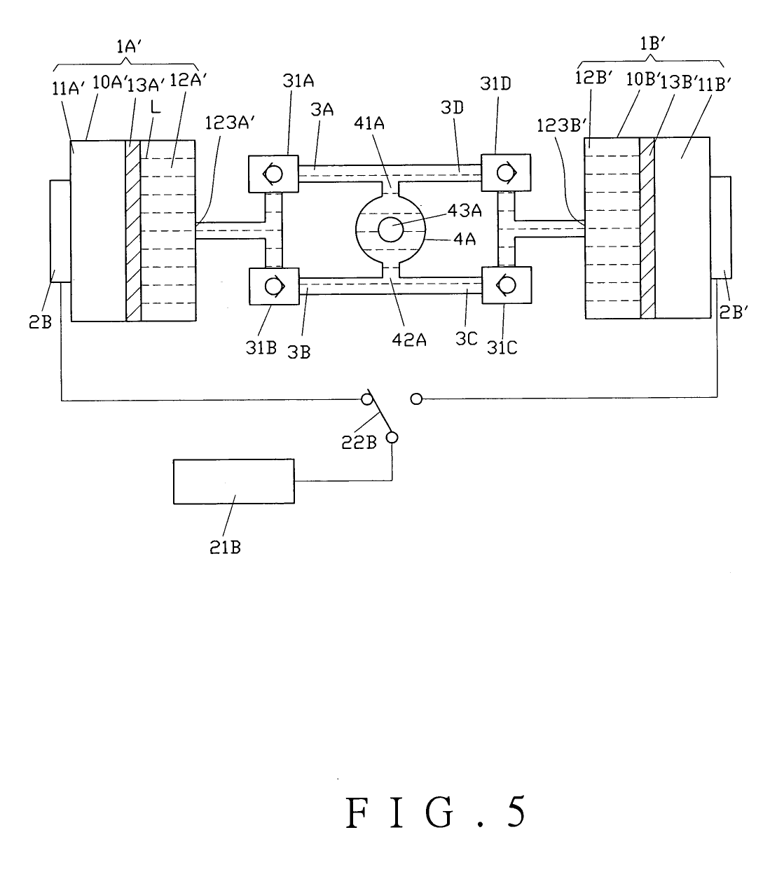

A third preferred embodiment of the present invention, as illustrated in FIG. 5, differs from the second preferred embodiment in that there is only one access (123A′) disposed to a hydraulic chamber (12A′) of a first cylinder (1A′) and there is only one access (123B′) disposed to a second cylinder (1B′). Two heat exchangers (2B, 2B′) are used. A controller (21B) is connected with a switch (22B) to intermittently control the heating to an air chamber (11A′) of the first cylinder (1A′) and an air chamber (11B′) of the second cylinder (1B′).

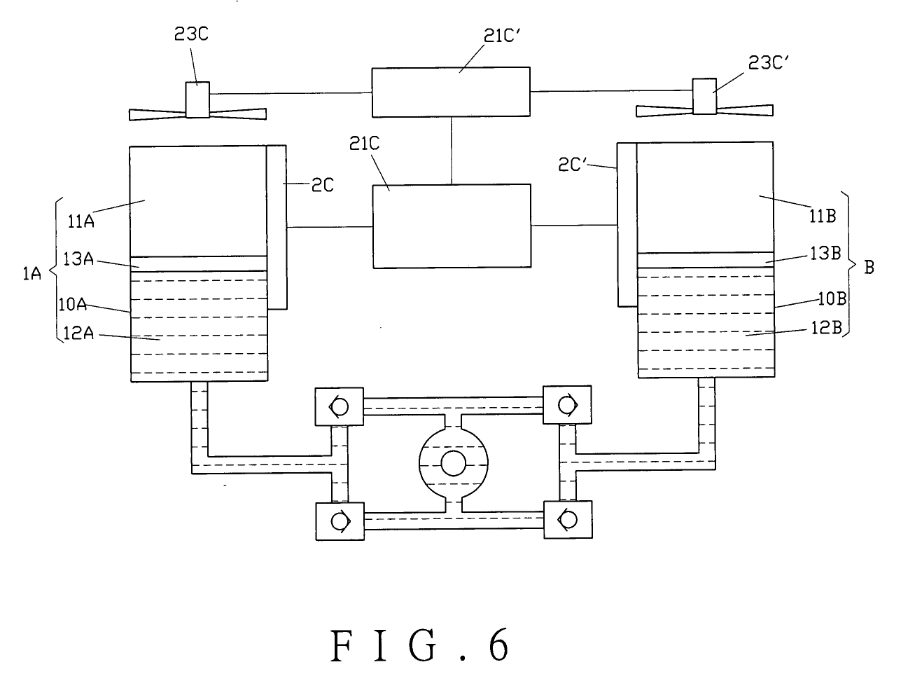

As illustrated in FIG. 6, a fourth preferred embodiment of the present invention differs the third preferred embodiment in that a controller (21C) controlling two heat exchangers (2C, 2C′) is connected to a heat dissipation controller (21C′) for the heat dissipation controller (21C′) to further control two fans (23C, 23C′) disposed respectively in relation to the air chamber (11A′) and the air chamber (11B′) of the first cylinder (1A′) and the second cylinder (1B′).

What is claimed is:

1. A thermo-driven engine comprising:
N cylinders including a first cylinder and a last cylinder, N being a positive integral and not less than 2, each cylinder having a body containing a pair of an air chamber and a hydraulic chamber, a piston being disposed between the air chamber and the hydraulic chamber, the air chamber containing a gaseous substance, the hydraulic chamber containing a liquid substance, an inlet and an outlet being disposed to the hydraulic chamber;
one or a plurality of heat exchanger disposed in relation to the air chamber of the cylinder, the heat exchanger being disposed to the air chamber of the first cylinder;
2×N pipelines, each of the pipelines being provided with a control valve to deliver the liquid substance in one direction; and
one or a plurality of hydraulic motor, the hydraulic motor being disposed with an inlet, an outlet, and an output shaft; when multiple hydraulic motors are provided, a first and a last hydraulic motors being designated; when only one hydraulic motor is provided, the first hydraulic motor being the last hydraulic motor;
whereby, both the inlet and the outlet of the hydraulic chamber of each cylinder being respectively connected with the pipelines to import or output the liquid substance, both the inlet and the outlet of the hydraulic motor being respectively connected with the pipelines to import or output the liquid substance, the output of the hydraulic chamber of the first cylinder being connected with the pipeline to the inlet of the first hydraulic motor, the outlet of the first hydraulic motor being connected with the pipeline to export the liquid substance, the liquid substance being further imported into the inlet of the next cylinder or the hydraulic motor until it reaches where the outlet of the last hydraulic motor is connected to the inlet of the hydraulic chamber of the first cylinder.

2. The thermo-driven engine of claim 1, wherein the control valve mounted to the pipeline is a one-way valve.

3. A thermo-driven engine comprising:
a first cylinder, the first cylinder containing an air chamber and a hydraulic chamber therein, a piston being disposed between the air chamber and the hydraulic chamber, the air chamber containing a gaseous substance, the hydraulic chamber containing a liquid substance, the hydraulic chamber being provided with an outlet connecting through a first hydraulic pipeline and an inlet connecting through a second hydraulic pipeline, a one-way valve being disposed to the first hydraulic pipeline;
a heat exchanger, the heat exchanger being disposed in relation to the air chamber of the first cylinder;
a first hydraulic motor, the first hydraulic motor being disposed with an inlet and an outlet with the inlet connecting through the first hydraulic pipeline of the first cylinder, an output shaft being disposed to the first hydraulic motor;
a second hydraulic motor, the second hydraulic motor being disposed with an inlet and an outlet with the outlet connecting through the second hydraulic pipeline of the first cylinder, an output shaft being disposed to the second hydraulic motor; and
a second cylinder, the second cylinder being connected through the first and the second hydraulic motors, the second cylinder containing an air chamber and a hydraulic chamber therein, a piston being disposed between the air chamber and the hydraulic chamber, the air chamber containing a gaseous substance, the hydraulic chamber containing a liquid substance, an inlet being disposed to the hydraulic chamber to connect through a third hydraulic pipeline and the outlet of the first hydraulic motor, an output being disposed to the hydraulic chamber to connect through a fourth hydraulic pipeline and the inlet of the second hydraulic motor, a one-way valve being disposed to the fourth hydraulic pipeline.

4. A thermo-driven engine comprising:
a first cylinder, the first cylinder containing an air chamber and a hydraulic chamber therein, a piston being disposed between the air chamber and the hydraulic chamber, the air chamber containing a gaseous substance, the hydraulic chamber containing a liquid substance, an inlet and an outlet being respectively disposed to the hydraulic chamber;
a heat exchanger, the heat exchanger including a controller to control intermittent heating and being disposed in relation to the air chamber of the first cylinder;
a second cylinder, the second cylinder containing an air chamber and a hydraulic chamber therein, the air chamber containing a gaseous substance, the hydraulic chamber containing a liquid substance, a piston being disposed between the air chamber and the hydraulic chamber, an inlet and an outlet being respectively provided to the hydraulic chamber;
a hydraulic motor, the hydraulic motor being provided with an inlet and an outlet;
a first hydraulic pipeline, the first hydraulic pipeline being provided with a one-way valve and connected to the outlet of the hydraulic chamber of the first cylinder and the inlet of the hydraulic motor;
a second hydraulic pipeline, the second hydraulic pipeline being provided with a one-way valve and connected to the outlet of the hydraulic motor and the inlet of the hydraulic chamber of the first cylinder;
a third hydraulic pipeline, the third hydraulic pipeline being provided with a one-way valve and connected to the outlet of the hydraulic motor and the inlet of the hydraulic chamber of the second cylinder; and
a fourth hydraulic pipeline, the fourth hydraulic pipeline being provided with a one-way valve and connected to the outlet of the hydraulic chamber of the second cylinder and the inlet of the hydraulic motor.

5. The thermo-driven engine of claim 4, wherein both the outlet and the inlet of the hydraulic chamber of the first cylinder are integrated into one access, and both the outlet and the inlet of the hydraulic chamber of the second cylinder are integrated into one access, the first hydraulic pipeline connecting the access of the hydraulic chamber of the first cylinder and the inlet of the hydraulic motor, the second hydraulic pipeline connecting the output of the hydraulic motor and the access of the hydraulic chamber of the first cylinder, the third hydraulic pipeline connecting the output of the hydraulic motor and the access of the hydraulic chamber of the second cylinder, the fourth hydraulic pipeline connecting the access of the hydraulic chamber of the second cylinder and the inlet of the hydraulic motor.

6. The thermo-driven engine of claim 4, wherein the controller of the heat exchanger is connected to a switch and the switch is further connected to another heat exchanger disposed in relation to the air chamber of the second cylinder.

7. The thermo-driven engine of claim 4, wherein the controller of the heat exchanger is connected to a heat dissipation controller, and the controller is further connected to another heat exchanger disposed in relation to the air chamber of the second cylinder, the heat dissipation controller controlling two fans disposed respectively in relation to the air chambers of the first and the second cylinders to control intermittent heating and heat dissipation for the first and second heat exchangers.
